(19) United States
(12) Patent Application Publication
(10) Pub. No.: US 2012/0055295 A1
(43) Pub. Date: Mar. 8, 2012

(54) LASER BEAM DEFLECTION TORQUE WRENCH

(76) Inventor: Michael G. Bruce, Catonsville, MD (US)

(21) Appl. No.: 13/213,749

(22) Filed: Aug. 19, 2011

Related U.S. Application Data
(60) Provisional application No. 61/376,572, filed on Aug. 24, 2010.

(51) Int. Cl. B25B 23/142; G01C 1/00

(52) U.S. Cl. 81/467; 33/263

(57) ABSTRACT

A torque wrench including an elongated beam having a first end and a second end, a drive post attached to the first end of the elongated beam, a handle attached to the second end of the elongated beam so that force applied to the handle transfers torque to the work piece, a scale attached to the second end of the elongated beam, and a laser source disposed on the first end of the elongated beam, the laser source being configured to direct a laser beam toward the second end of the elongated beam such that the laser beam strikes the scale.

### CLAIM OF PRIORITY

This application claims priority to U.S. Provisional Patent Application No. 61/376,572 filed Aug. 24, 2010, the entire disclosure of which is incorporated by reference herein.

### FIELD OF THE INVENTION

The present invention relates generally to torque wrenches. More specifically, the present invention relates to deflection beam torque wrenches.

### BACKGROUND OF THE INVENTION

Mechanical torque wrenches are well known. As shown in FIGS. 1 and 2, a typical deflection beam torque wrench 10 includes an elongated beam 12, a drive post 14, a hand grip 16, a scale 18 and a corresponding pointer 20. Hand grip 16 is secured to a first end of elongated beam 12 along with scale 18. Scale 18 extends outwardly to the right and the left sides of elongated beam 12 such that the amount of torque being applied by torque wrench 10 in either the clockwise or counter-clockwise directions can be measured, respectively. Drive post 14 is disposed at a second end of the elongated beam and typically includes a drive tang 8 that is configured to receive variously sized sockets, thereby allowing a user to apply torque to different sized fasteners. Additionally, a proximal end of pointer 20 is fixed to drive post 14 and pointer 20 extends along the longitudinal center axis of elongated beam 12 such that a distal end of pointer 20 is adjacent scale 18.

When no torque is being applied with torque wrench 10, the distal end of pointer 20 is disposed adjacent the center of scale 18, which corresponds to the longitudinal center axis of elongated beam 12. As torque is applied, resistance to rotation of torque wrench 10 provided by the fastener being driven causes deflection of the handle end of elongated beam 12 relative to the drive post end in the direction in which torque is being applied. In contrast, the pointer is not deflected relative to the drive post end of elongated beam 12 as it is free to rotate therewith. As such, deflection of the handle end of torque wrench 10 causes movement of scale 18 relative to the distal end of pointer 20, thereby indicating the amount of torque being applied to the fastener.

Various issues exist with regard to the use of existing deflection beam torque wrenches. For example, they can be difficult to store because of the size of the scale extending outwardly from the elongated beam, pointers can be easily damaged, thereby affecting accuracy, and the accuracy of the wrench depends largely upon the user viewing the scale and associated pointer directly from above the scale.

The present invention recognizes and addresses considerations of prior art constructions and methods.

### SUMMARY OF THE INVENTION

A first embodiment of the present disclosure provides a torque wrench which includes an elongated beam having a first end and a second end, a drive post attached to the first end of the elongated beam, the drive post being configured to attach to a work piece to transfer torque to the work piece, a handle attached to the second end of the elongated beam so that force applied to the handle transfers torque to the work piece, a scale attached to the second end of the elongated beam, and a laser source disposed on the first end of the elongated beam, the laser source being configured to direct a laser beam toward the second end of the elongated beam such that the laser beam strikes the scale.

A second embodiment of the present disclosure provides a torque wrench which includes an elongated beam having a first end and a second end, the first end being configured to attach to a work piece to transfer torque to the work piece and the second end being configured to be gripped by a user so that force applied to the second end transfers torque to the work piece, a scale attached to the elongated beam, and a laser source disposed on the first end of the elongated beam, the laser source being configured to direct a laser beam toward the second end of the elongated beam such that the laser beam strikes the scale.

Yet another embodiment of the present disclosure provides a laser beam assembly for use with a torque wrench including a drive post at a first end, a grip handle at an opposite second end, and a scale. The laser beam assembly includes a laser source disposed on the first end of the torque wrench, the laser source being configured to direct a laser beam toward the second end of the torque wrench such that the laser beam strikes the scale.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a top view of a prior art deflection beam torque wrench;

FIG. 2 is a side view of the deflection beam torque wrench shown in FIG. 1;

FIG. 3 is a perspective view of a laser beam deflection torque wrench in accordance with an embodiment of the present disclosure;

FIG. 4 is a perspective view of the laser beam deflection torque wrench shown in FIG. 3;

FIG. 5 is a top view of the laser beam deflection torque wrench shown in FIG. 3;

FIG. 6 is a side view of the laser beam deflection torque wrench shown in FIG. 3;

FIGS. 7A and 7B are partial, cut-away front and side views, respectively, of the drive post end of the laser beam deflection torque wrench shown in FIG. 3;

FIG. 8 is a top view of the laser beam deflection torque wrench shown in FIG. 3 applying torque in the clockwise direction;

FIG. 9 is a top view of an alternate embodiment of a laser beam deflection wrench in accordance with the present disclosure;

FIG. 10 is a side view of the laser beam deflection torque wrench shown in FIG. 9; and

FIGS. 11A, 11B, 11C and 11D are partial, cut-away front, side, top and rear views of the dive post end of the laser beam deflection torque wrench shown in FIG. 9.

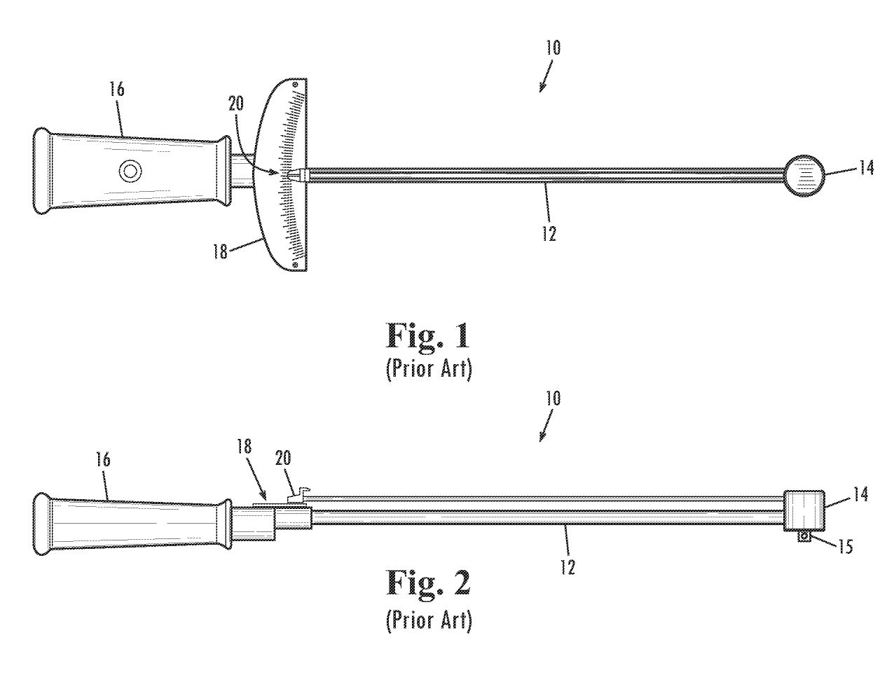

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

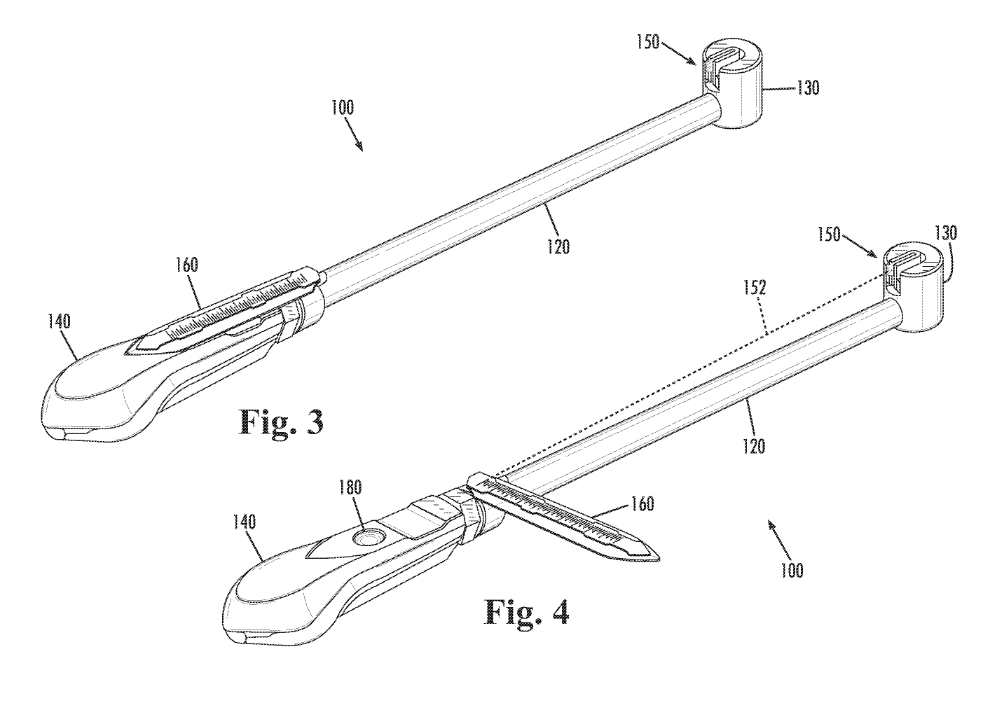

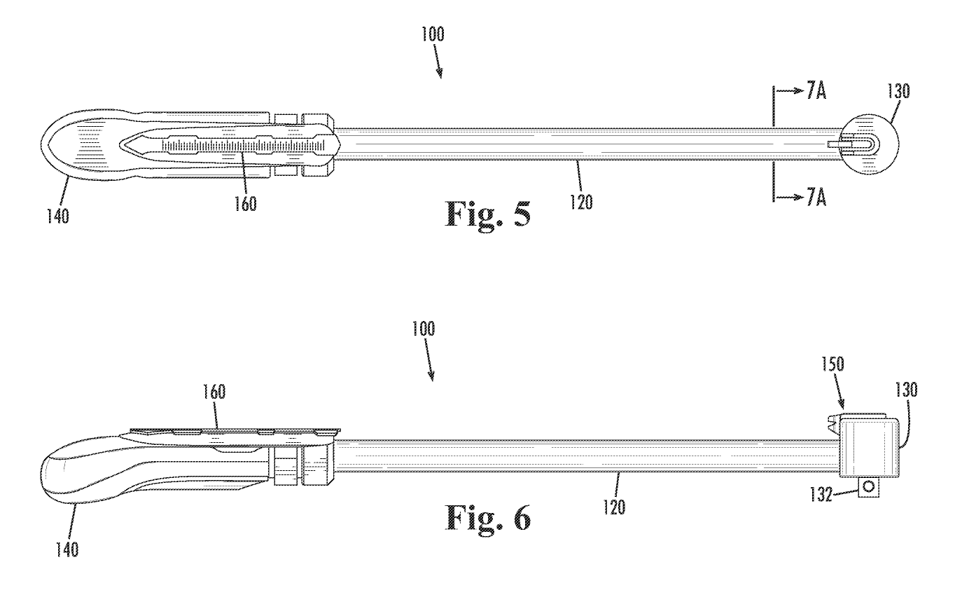

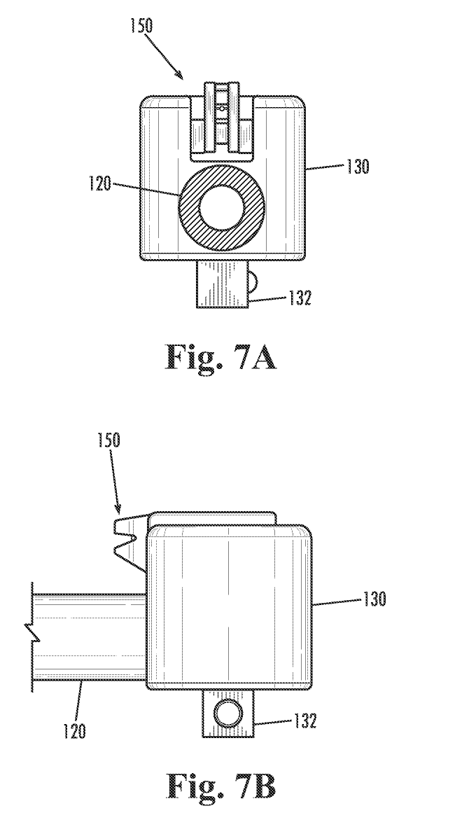

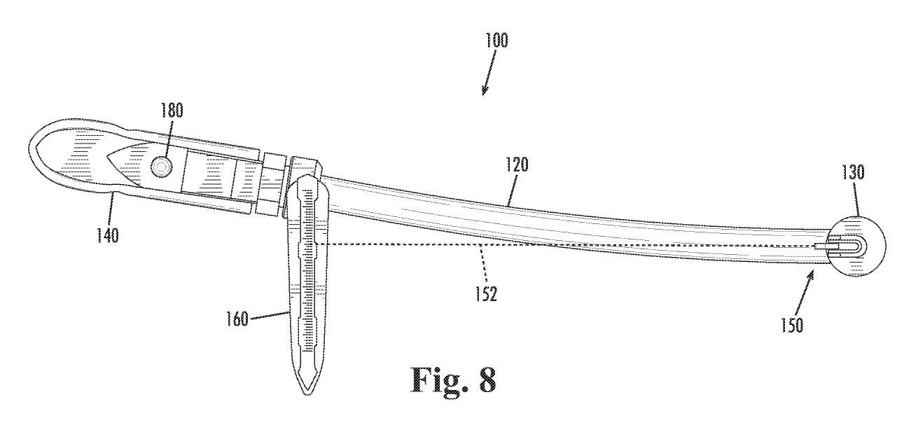

As shown in FIGS. 3 through 8, a laser beam deflection torque wrench 100 in accordance with the present disclosure includes an elongated beam 120, a drive post 130 fixed to a first end of elongated beam 120 and a grip handle 140 affixed to a second end of elongated beam 120. As best seen in FIGS. 7A and 7B, drive post 130 includes a laser source 150 and a drive tang 132 for receiving variously sized sockets (not shown). Laser source 150 is configured to direct a laser beam 152 along the longitudinal center axis of elongated beam 120 when the torque wrench is powered on and no torque is being applied with the wrench. As best seen in FIG. 4, a graduated scale 160 is pivotably mounted adjacent grip handle 140 and is selectively pivotable to the right-hand side or the left-hand side of elongated beam 120 dependant upon whether torque is applied to a fastener in the clockwise direction or the counter-clockwise direction, respectively. When rotated over the centerline of grip handle 140, graduated scale 160 serves as a protective cover for a power button 180 that is used to turn the power source for laser source 150 on and off. Preferably, grip handle 140 also includes a battery compartment (not shown) for receiving a power source for the laser source.

In use, a user first presses power button 180 to turn the torque wrench on such that laser source 150 directs laser beam 152 along the longitudinal center axis of elongated beam 120. The laser beam is configured to strike graduated scale 160 at a zero value when no torque is being applied. Next, the user pivots graduated scale 160 to the side of elongated beam 120 that is opposite to the direction in which torque is to be applied. For example, as shown in FIG. 4, when viewed from above by the user, graduated scale 160 is rotated outwardly to the right-hand side of elongated beam 120 when torque is being applied in a clockwise direction. As torque is applied to, for example, a fastener, increasing resistance of the fastener to being rotated causes the grip handle end of elongated beam 120, and therefore graduated scale 160, to deflect relative to the drive post end of elongated beam 120 in the direction in which torque is being applied. In contrast, laser beam 152 remains as a straight line emanating radially outwardly from drive post 130. As such, as greater amounts of torque are applied with the torque wrench, and elongated beam 120 undergoes greater deflection, laser beam 152 strikes graduated scale 160 farther out from the zero reference point, indicating that greater amounts of torque are being applied. When applying torque in the counter-clockwise direction, a user rotates graduated scale 160 outwardly from elongated beam 120 to the left-hand side.

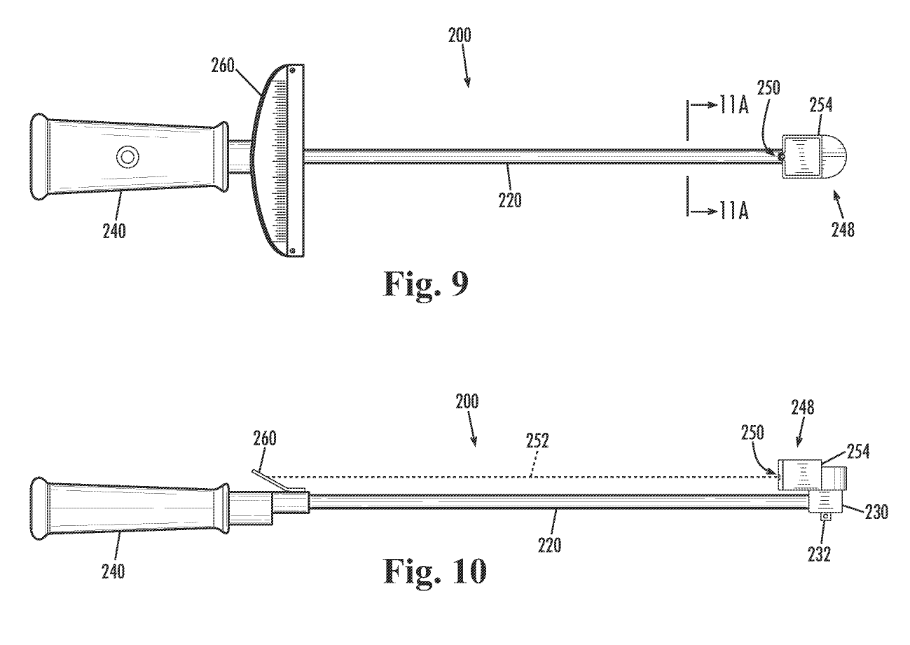

As shown in FIGS. 9 and 10, an alternate embodiment of a laser beam deflection torque wrench 200 in accordance with the present disclosure includes an elongated beam 220, a drive post 230 fixed to a first end of elongated beam 220, a grip handle 240 affixed to a second end of elongated beam 220, a scale 260, and a laser source assembly 248. Laser source assembly 248 is removably secured to drive post 230, which includes a drive tang 232 for receiving variously sized sockets (not shown).

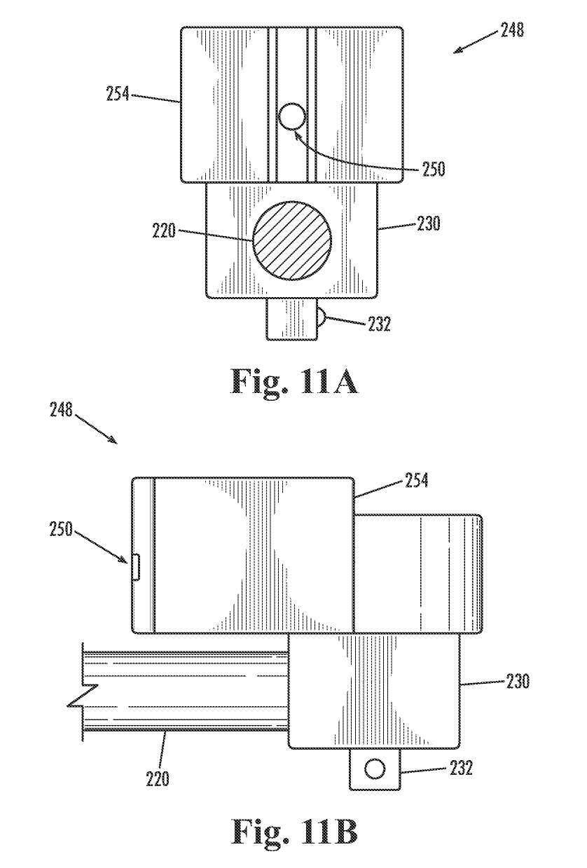

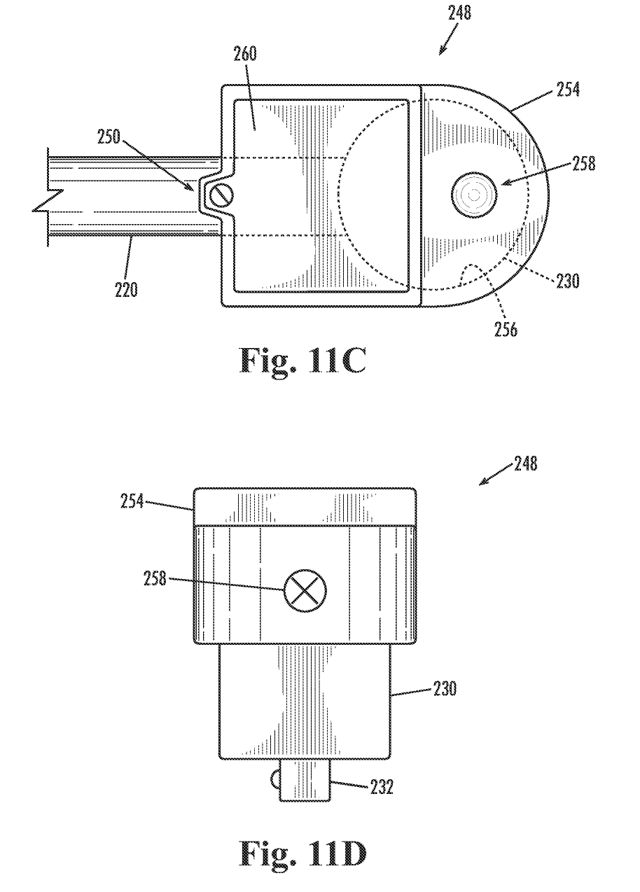

As best seen in FIGS. 11A through 11D, laser source assembly 248 includes a laser source 250 disposed in a housing 254. Housing 254 defines a mounting recess 256 that is configured to slidably receive an upper portion of drive post 230 in a press-fit. As such, laser source assembly 248 is selectively removable from drive post 230. Preferably, a threaded fastener 258 extends radially inwardly into mounting recess 256 to further secure laser source assembly 248 to mounting post 230. Note, in alternate embodiments, laser source assembly 248 is permanently fixed to drive post 230, such as by stacking, crimping, epoxy, welding, etc. Additionally, housing 254 defines a battery compartment (not shown) that is accessible by way of cover 260.

Laser source 250 is configured to direct a laser beam 252 along the longitudinal center axis of elongated beam 220 when the torque wrench is powered on and no torque is being applied with the wrench. Graduated scale 260 is mounted adjacent grip handle 240 such that laser beam 252 strikes the scale.

In use, a user first presses a power button 258 to turn laser source assembly 248 on such that laser source 250 directs laser beam 252 along the longitudinal center axis of elongated beam 220. The laser beam is configured to strike graduated scale 260 at a zero value when no torque is being applied. As torque is applied to, for example, a fastener, increasing resistance of the fastener to being rotated causes the grip handle end of elongated beam 220, and therefore graduated scale 260, to deflect relative to the drive post end of elongated beam 220 in the direction in which torque is being applied. In contrast, laser beam 252 remains as a straight line emanating radially outwardly from drive post 230. As such, as greater amounts of torque are applied with the torque wrench, and elongated beam 220 undergoes greater deflection, laser beam 252 strikes graduated scale 260 farther out from the zero reference point, indicating that greater amounts of torque are being applied.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed is:

1. A torque wrench comprising:
an elongated beam having a first end and a second end;
a drive post attached to the first end of the elongated beam, the drive post being configured to attach to a work piece to transfer torque to the work piece;
a handle attached to the second end of the elongated beam so that force applied to the handle transfers torque to the work piece;
a scale attached to the second end of the elongated beam; and
a laser source disposed on the first end of the elongated beam, the laser source being configured to direct a laser beam toward the second end of the elongated beam such that the laser beam strikes the scale.

2. The torque wrench of claim 1, wherein the scale is disposed between the drive post and the handle.

3. The torque wrench of claim 1, wherein the laser source is disposed at least partially within the drive post.

4. The torque wrench of claim 1, wherein the laser source is removably attached to the drive post.

5. The torque wrench of claim 4, further comprising a housing, wherein the laser source is disposed within the housing and the housing is removably attached to the drive post.

6. The torque wrench of claim 5, wherein the housing further comprises a battery compartment.

7. The torque wrench of claim 5, wherein the housing further comprises a mounting recess adapted to receive a portion of the drive post.

8. The torque wrench of claim 7, wherein the mounting recess of the housing receives the portion of the drive post in a press-fit.

9. The torque wrench of claim 7, further comprising a fastener extending radially inwardly into the mounting recess of the housing, the fastener being configured to engage the portion of the drive post disposed within the mounting recess such that the housing is non-rotatably fixed to the drive post.

10. The torque wrench of claim 1, wherein the scale is pivotably mounted to the second end of the elongated beam such that the scale can be pivoted outwardly to opposing sides of the elongated beam.

11. The torque wrench of claim 1, further comprising a battery compartment disposed within the handle.

12. The torque wrench of claim 1, wherein the drive post further comprises a drive tang configured to receive a drive socket.

13. A torque wrench comprising:
an elongated beam having a first end and a second end, the first end being configured to attach to a work piece to transfer torque to the work piece and the second end being configured to be gripped by a user so that force applied to the second end transfers torque to the work piece;
a scale attached to the elongated beam; and
a laser source disposed on the first end of the elongated beam, the laser source being configured to direct a laser beam toward the second end of the elongated beam such that the laser beam strikes the scale.

14. The torque wrench of claim 13, further comprising a drive post attached to the first end of the elongated beam.

15. The torque wrench of claim 14, further comprising a handle attached to the second end of the elongated beam.

16. The torque wrench of claim 13, wherein the scale is disposed at the second end of the elongated beam between the drive post and the handle.

17. The torque wrench of claim 13, wherein the laser source is disposed at least partially within the drive post.

18. The torque wrench of claim 13, wherein the laser source is removably attached to the drive post.

19. The torque wrench of claim 18, further comprising a housing, wherein the laser source is disposed within the housing and the housing is removably attached to the drive post.

20. The torque wrench of claim 19, wherein the housing further comprises a mounting recess adapted to receive a portion of the drive post.

21. The torque wrench of claim 13, wherein the scale is pivotably mounted to the second end of the elongated beam such that the scale can be pivoted outwardly to opposing sides of the elongated beam.

22. A laser beam assembly for use with a torque wrench including a drive post at a first end, a grip handle at an opposite second end, and a scale, the laser beam assembly comprising:
a laser source disposed on the first end of the torque wrench, the laser source being configured to direct a laser beam toward the second end of the torque wrench such that the laser beam strikes the scale.

23. The torque wrench of claim 22, wherein the laser source is disposed at least partially within the drive post.

24. The torque wrench of claim 22, wherein the laser source is removably attached to the drive post.

25. The torque wrench of claim 24, further comprising a housing, wherein the laser source is disposed within the housing and the housing is removably attached to the drive post.

26. The torque wrench of claim 25, wherein the housing further comprises a battery compartment.

27. The torque wrench of claim 25, wherein the housing further comprises a mounting recess adapted to receive a portion of the drive post.
